(19) United States
(12) Patent Application Publication
(10) Pub. No.: US 2006/0068122 A1
(43) Pub. Date: Mar. 30, 2006

(54) Method for replenishing or introducing light stabilizers

(76) Inventors: Mouhcine Kanouni, New York, NY (US); Simon Lord, Prahran (AU); Nancy Cliff, Ringwood, NJ (US); Kyle Richard Jones, Middletown, DE (US)

Correspondence Address: CIBA SPECIALTY CHEMICALS CORPORATION;PATENT DEPARTMENT, 540 WHITE PLAINS RD, P O BOX 2005, TARRYTOWN, NY, 10591-9005, US

(21) Appl. No.: 11/235,571

(22) Filed: Sep. 26, 2005

Related U.S. Application Data
(60) Provisional application No. 60/614,676, filed on Sep. 30, 2004.

(51) Int. Cl. B05D 3/00

(52) U.S. Cl. 427/532

(57) ABSTRACT

This invention is a method for incorporating light stabilizers into a polymeric material such as coatings, paints and plastics, which comprises the steps of applying a coating of a composition comprising a light stabilizer on the polymeric material and allowing the coating to remain in contact with the polymeric material for a time sufficient to cause the light stabilizer to diffuse into the polymeric material. No active heating of the polymeric substrate is required. Ambient conditions encountered in natural outdoor weathering will suffice to allow diffusion of stabilizers. Other additives affecting the aging or performance of the polymeric material can also be incorporated by this method.

This application claims benefit under 35 USC 119(e) of U.S. provisional application No. 60/614,676, filed Sep. 30, 2004.

This invention is related to a method to incorporate light stabilizers into polymeric material substrates.

### BACKGROUND OF THE INVENTION

The long term weatherability of automotive coatings, marine coatings and other polymers which are exposed to outdoor conditions is dependent in large part on the ability of light stabilizer additives contained in the polymer to shield underlying material from ultraviolet (UV) light and to protect the polymer against the spread of degradative reactions initiated by this light. For this reason, UV light absorbers (UVA) such as benzotriazoles and radical traps such as hindered amine light stabilizers (HALS) are routinely added to polymer compositions. However, over time these stabilizers may be chemically broken down or migrate out of the polymer, especially from the surface. The result is that coatings and plastics are subject to photo-degradation which degrades their properties, e.g., the paint loses its gloss, colors fade or the plastic becomes brittle or discolors. This problem is particularly pronounced in automotive coatings where complete failure or delamination of the coating layer may ultimately occur.

Generally, polishes are periodically applied on an automobile paint surface to revitalize its gloss and increase its water repellency. One such topical treatment is disclosed in U.S. Pat. No. 5,288,314 to Howard et al. and contains dye, solvent, UV additive and a number of other components including silicone. U.S. Pat. No. 6,685,765 to Ghodoussi discloses a protective wax composition which contains among other components UV absorbers and light stabilizers. Neither patent discloses a means of furnishing light stabilizers into the paint resin itself.

The need to frequently reapply automotive polishes to revitalize paint gloss is indicative of their temporary and topical nature. It would be more effective to employ a method to replenish light stabilizers into the paint or clear coat to provide continuing effective UV degradation resistance to the paint.

Likewise, light stabilizers are chemically degraded or otherwise lost from thermoplastic articles which would also benefit from such a method of stabilizer replenishment.

It is well known that light stabilizers (LS), UVAs and HALS, are lost most rapidly from the surface where they are most needed to protect the coating or polymeric article from incident UV light. Thus, replenishment of the LS at the surface of a coating system or polymer article would offer the greatest stabilization effect.

One such method for replenishing UVAs into automotive coatings is disclosed in U.S. Pat. No. 5,487,914. This method however requires an added heating step.

In a similar vein, U.S. Pat. Nos. 4,322,455 and 4,323,597 disclose a method for impregnating the surface of polycarbonate with UVAs. Again, an added heating step is required.

U.S. Pat. No. 4,146,658 also discloses a method for surface impregnation of polycarbonate. All of the examples comprise heating the polycarbonate to 250° F. Furthermore, U.S. Pat. Nos. 4,146,658; 4,322,455 and 4,323,597 all require a selection of very specific solvents to both facilitate UVA penetration and prevent marring of the polymer surface.

The present invention provides a general method for incorporating light stabilizers into polymeric materials such as automotive coatings, marine coatings, protective and functional films, thermoplastic articles and thermoplastic composite articles like plastic lumber which requires no active heating of the polymer. This method can be used to either replenish LS into an aged or weathered material, introduce LS to non-light stabilized material, or fortify the LS of an already stabilized system. Ambient conditions typically encountered in outdoor weathering, e.g. exposure to sunlight on a warm day, will suffice to allow diffusion of stablizers into the polymeric surface. Thus, a further advantage of the present invention is that the method can be incorporated into routine maintenance activities such as washing or cleaning the article.

### SUMMARY OF THE INVENTION

This invention is directed to a method for incorporating light stabilizers into a polymeric substrate, which method comprises the steps of:

providing a removable coating composition comprising an effective amount of an ultraviolet light absorber, a hindered amine light stabilizer or both formulated with a non-reactive carrier with sufficient viscosity or film forming properties to maintain a coherent layer on the polymeric substrate for a time sufficient to allow the ultraviolet light absorber, hindered amine light stabilizer or both to diffuse into the substrate; and

allowing the coating layer to remain in contact with the polymeric substrate for said sufficient time to allow the ultraviolet light absorber, hindered amine light stabilizer or both to diffuse into the substrate.

Residue of the coating layer may be removed by methods such as washing etc. after sufficient stabilizer diffusion has occurred. Alternately, the coating residue may be left on the substrate indefinitely or left on the substrate until natural erosion or wear causes removal of the coating residue.

The composition may be in liquid, emulsified liquid, gel or low melting solid form. The composition may also include a substantially non-volatile solvent capable of swelling the substrate.

By controlling viscosity or film forming properties of the coating composition, no active heating of the polymeric substrate is required either before or after application of the coating of the instant invention. Ambient conditions such as those encountered in natural outdoor weathering will suffice to allow diffusion of stabilizers.

The present invention can be used to replace light stabilizers which are lost from the surface of a coating system during weathering, for example an automobile coating, a marine gel coat or any other painted object.

The present invention can also be used to replace light stabilizers which are lost from a thermoplastic article or a polymeric film during weathering.

The present invention can also be used to add light stabilizers to a polymer system prior to weathering. Examples when post processing stabilizer addition is beneficial include a photo-cured system where the presence of certain light stabilizers might interfere with cure, a thick article where the light stabilizers are needed only at the surface rather than throughout the bulk or when processing conditions are too demanding, e.g., high heat or strong acid catalyst, for the stabilizers to be added earlier.

When using this invention to add light stabilizers to a previously unstabilized or polymer system, or to fortify the existing stabilizer formulation of the polymeric article, it is sometimes beneficial to ‘weather’ the article for a short time prior to application of the coating compositions of the present invention. This can improve the rate of stabilizer diffusion in to the substrate. To ‘weather’ a substrate means to expose the substrate to environmental conditions typically associated with degradative wear of the article. Such weathering methods include ambient outdoor exposure and accelerated aging methods such as exposure to artificial Ultra Violet light.

Other additives affecting the aging or performance of the polymeric material can also be incorporated by this method.

### DETAILED DESCRIPTION OF THE INVENTION

The present invention relates to a method for incorporating light stabilizers, e.g., ultraviolet light absorbers (UVAs) and hindered amine light stabilizers (HALS) into a polymeric material, e.g., a thermoset or photo-cured coating or paint, a marine gel coat, a molded thermoplastic article, an article produced from a composite material like plastic lumber (a blend of polymers and wood shavings, wood flour or other wood particles) or a protective film. The method is employed at any time after the polymeric material has been processed or put into use, for example, after a coating is cured, an article shaped or a film applied, but is particularly useful to replenish stabilizers lost as a result of weathering.

Light stabilizers, UVAs and HALS, are lost most rapidly from the surface of a coating where they are most needed to protect the coating from incident UV light. One particularly desirable use for the present invention is to replenish UVAs into paints and coatings, i.e., after the paint has been applied to the article and the cured paint coating has experienced exposure in the environment to UV light. As would be apparent in view of this disclosure, however, the method is not so limited.

Paints and coatings which would benefit from the present method are readily apparent to those skilled in the art in view of the present disclosure and include, but are not limited to, those used as basecoats and clear coats in automotive applications. Exemplary of such automotive coatings are acrylic/melamine, acrylic/urethane, polyester/urethane, and epoxy/acid type paints and include coatings based on or incorporating silane functionality.

It is also readily apparent that other coating systems including marine coatings, wood coatings, other coatings for metals and coatings over plastics and ceramics would benefit from the present disclosure. Exemplary of such marine coatings are gel coats comprising an unsaturated polyester, a styrene and a catalyst.

In addition to coatings, other polymeric materials, such as thermoplastics, which would benefit from having a LS replenished can be subjected to the invention method.

Plastics which would benefit from the present method include, but are not limited to, plastics used in the manufacture of automotive or machine parts, outdoor furniture, boats, vinyl siding, protective films, decals, sealants, composites like plastic lumber and fiber reinforced composites, and functional films including polarizing, conducting and other films used in displays. Exemplary of such plastics are polypropylene, polyethylene, PVC, styrenics, polyamides, aliphatic urethanes, aliphatic polyesters, thermoplastic polyolefins, ionomers, unsaturated polyesters and blends of polymer resins including ABS, SAN and PC/ABS. For Example, the plastic is a polyolefin.

The final form of the polymeric substrate is not relevant. For example molded articles such as automotive fascia and mailboxes as well as articles constructed from synthetic fibers such as awnings, carpets and furniture parts, and rubber articles such as outdoor matting can all benefit from the present method for stabilizer replenishment.

There are occasions where processing conditions or the presence of interactive materials prevent the addition of LS to a polymeric material during processing. Also, there may be a need to increase the concentration of LS at the surface of a polymeric material which already contains a certain amount of LS. Another aspect of the present invention is therefore a method for adding LS to unweathered or lightly weathered polymeric materials to either introduce LS to a material which does not contain LS or to fortify the surface of a material to which LS have been already added. Examples of such polymeric materials include the same materials and products as recited above.

The light stabilizing composition comprises, at a minimum, a non-reactive carrier and at least one light stabilizing compound selected from the group consisting of UV absorbers and HALS. A non-reactive carrier is a carrier that is substantially non-reactive toward the UV absorber, the HALS or the polymer. This carrier may be a liquid or low melting solid (i.e., having a melting point below about 50° C.), but is preferably a liquid because it optimally insures intimate contact between the carrier and the polymeric material substrate during the invention method. The carrier may be a single component or comprise a mixture of components which may be volatile or non-volatile. The particular carrier is not critical to the invention method as long as it wets the polymeric material surface during the invention method.

The light stabilizing composition is also formulated to have a viscosity high enough to remain in contact with the polymeric material for a period of time sufficient to allow for the diffusion of the stabilizers into the polymer. The carrier may therefore also comprise thickeners and other rheology modifiers.

The UVA included in the composition may be any such additive, or mixture of UVAs, many of which are well known in the art. Exemplary of such materials are 2-(2-hydroxyphenyl)-2H-benzotriazoles, tris-aryl-o-hydroxyphenyl-s-triazines, ortho-hydroxybenzophenones, cyanoacrylates, oxanilides, benzylidene malonates, benzoxazinone UV absorbers, esters of substituted and unsubstituted benzoic acids including cinnamates and salicylates, formamidines, dibenzoylmethanes and esters of para-aminobenzoic acid. The exact UVA or mixture of UVAs chosen will depend largely on the particular application. For example, for more demanding applications, the more robust UVAs, e.g., benzotriazoles, ortho-hydroxybenzophenones, triphenyltriazines, cyanoacrylates, oxanilides, benzylidene malonates, will be preferred.

2-(2-Hydroxyphenyl)-2H-benzotriazoles are, for example, known commercial hydroxyphenyl-2H-benzotriazoles and benzotriazoles as disclosed in U.S. Pat. Nos. 3,004,896; 3,055,896; 3,072,585; 3,074,910; 3,189,615; 3,218,332; 3,230,194; 4,127,586; 4,226,763; 4,275,004; 4,278,589; 4,315,848; 4,347,180; 4,383,863; 4,675,352; 4,681,905,4,853,471; 5,268,450; 5,278,314; 5,280,124; 5,319,091; 5,410,071; 5,436,349; 5,516,914; 5,554,760; 5,563,242; 5,574,166; 5,607,987, 5,977,219 and 6,166,218 such as 2-(2-hydroxy-5-methylphenyl)-2H-benzotriazole, 2-(3,5-di-t-butyl-2-hydroxyphenyl)-2H-benzotriazole, 2-(2-hydroxy-5-t-butylphenyl)-2H-benzotriazole, 2-(2-hydroxy-5-t-octylphenyl)-2H-benzotriazole, 5-chloro-2-(3,5-di-t-butyl-2-hydroxyphenyl)-2H-benzotriazole, 5-chloro-2-(3-t-butyl-2-hydroxy-5-methylphenyl)-2H-benzotriazole, 2-(3-sec-butyl-5-t-butyl-2-hydroxyphenyl)-2H-benzotriazole, 2-(2-hydroxy-4-octyloxyphenyl)-2H-benzotriazole, 2-(3,5-di-t-amyl-2-hydroxyphenyl)-2H-benzotriazole, 2-(3,5-bis-α-cumyl-2-hydroxyphenyl)-2H-benzotriazole, 2-(3-t-butyl-2-hydroxy-5-(2-(ω-hydroxy-octa-(ethyleneoxy)carbonyl-ethyl)-, phenyl)-2H-benzotriazole, 2-(3-dodecyl-2-hydroxy-5-methylphenyl)-2H-benzotriazole, 2-(3-t-butyl-2-hydroxy-5-(2-octyloxycarbonyl)ethylphenyl)-2H-benzotriazole, dodecylated 2-(2-hydroxy-5-methylphenyl)-2H-benzotriazole, 2-(3-t-butyl-2-hydroxy-5-(2-octyloxycarbonylethyl)phenyl)-5-chloro-2H-benzotriazole, 2-(3-tert-butyl-5-(2-(2-ethylhexyloxy)-carbonylethyl)-2-hydroxyphenyl)-5-chloro-2H-benzotriazole, 2-(3-t-butyl-2-hydroxy-5-(2-methoxycarbonylethyl)phenyl)-5-chloro-2H-benzotriazole, 2-(3-t-butyl-2-hydroxy-5-(2-methoxycarbonylethyl)phenyl)-2H-benzotriazole, 2-(3-t-butyl-5-(2-(2-ethylhexyloxy)carbonylethyl)-2-hydroxyphenyl)-2H-benzotriazole, 2-(3-t-butyl-2-hydroxy-5-(2-isooctyloxycarbonylethyl)phenyl-2H-benzotriazole, 2,2′-methylene-bis(4-t-octyl-(6-2H-benzotriazol-2-yl)phenol), 2-(2-hydroxy-3-α-cumyl-5-t-octylphenyl)-2H-benzotriazole, 2-(2-hydroxy-3-t-octyl-5-α-cumylphenyl)-2H-benzotriazole, 5-fluoro-2-(2-hydroxy-3,5-di-α-cumylphenyl)-2H-benzotriazole, 5-chloro-2-(2-hydroxy-3,5-di-α-cumylphenyl)-2H-benzotriazole, 5-chloro-2-(2-hydroxy-3-α-cumyl-5-t-octylphenyl)-2H-benzotriazole, 2-(3-t-butyl-2-hydroxy-5-(2-isooctyloxycarbonylethyl)phenyl)-5-chloro-2H-benzotriazole, 5-trifluoromethyl-2-(2-hydroxy-3-α-cumyl-5-t-octylphenyl)-2H-benzotriazole, 5-trifluoromethyl-2-(2-hydroxy-5-t-octylphenyl)-2H-benzotriazole, 5-trifluoromethyl-2-(2-hydroxy-3,5-di-t-octylphenyl)-2H-benzotriazole, methyl 3-(5-trifluoromethyl-2H-benzo-triazol-2-yl)-5-t-butyl-4-hydroxyhydrocinnamate, 5-butylsulfonyl-2-(2-hydroxy-3-α-cumyl-5-t-octylphenyl)-2H-benzotriazole, 5-trifluoromethyl-2-(2-hydroxy-3-α-cumyl-5-t-butyl-phenyl)-2H-benzotriazole, 5-trifluoromethyl-2-(2-hydroxy-3,5-di-t-butylphenyl)-2H-benzo-triazole, 5-trifluoromethyl-2-(2-hydroxy-3,5-di-α-cumylphenyl)-2H-benzotriazole, 5-butylsulfonyl-2-(2-hydroxy-3,5-di-t-butylphenyl)-2H-benzotriazole and 5-phenylsulfonyl-2-(2-hydroxy-3,5-di-t-butylphenyl)-2H-benzotriazole.

Tris-aryl-o-hydroxyphenyl-s-triazines are, for example, known commercial tris-aryl-o-hydroxyphenyl-s-triazines and triazines as disclosed in U.S. Pat. Nos. 3,843,371; 4,619,956; 4,740,542; 5,096,489; 5,106,891; 5,298,067; 5,300,414; 5,354,794; 5,461,151; 5,476,937; 5,489,503; 5,543,518; 5,556,973; 5,597,854; 5,681,955; 5,726,309; 5,736,597; 5,942,626; 5,959,008; 5,998,116; 6,013,704; 6,060,543; 6,242,598 and 6,255,483, for example 4,6-bis-(2,4-dimethylphenyl)-2-(2-hydroxy-4-octyloxyphenyl)-s-triazine, 4,6-bis-(2,4-dimethylphenyl)-2-(2,4-dihydroxyphenyl)-s-triazine, 2,4-bis(2,4-dihydroxyphenyl)-6-(4-chlorophenyl)-s-triazine, 2,4-bis[2-hydroxy-4-(2-hydroxy-ethoxy)phenyl]-6-(4-chlorophenyl)-s-triazine, 2,4-bis[2-hydroxy-4-(2-hydroxy-4-(2-hydroxyethoxy)phenyl]-6-(2,4-dimethylphenyl)-s-triazine, 2,4-bis[2-hydroxy-4-(2-hydroxy-ethoxy)phenyl]-6-(4-bromophenyl)-s-triazine, 2,4-bis[2-hydroxy-4-(2-acetoxyethoxy)-phenyl]-6-(4-chlorophenyl)-s-triazine, 2,4-bis(2,4-dihydroxyphenyl)-6-(2,4-dimethylphenyl)-s-triazine, 2,4-bis(4-biphenylyl)-6-(2-hydroxy-4-octyloxycarbonyl-ethylideneoxyphenyl)-s-triazine, 2-phenyl-4-[2-hydroxy-4-(3-sec-butyloxy-2-hydroxy-propyloxy)phenyl]-6-[2-hydroxy-4-(3-sec-amyloxy-2-hydroxypropyloxy)phenyl]-s-triazine, 2,4-bis(2,4-dimethylphenyl)-6-[2-hydroxy-4-(3-benzyloxy-2-hydroxypropyloxy)phenyl]-s-triazine, 2,4-bis(2-hydroxy-4-n-butyloxyphenyl)-6-(2,4-di-n-butyloxyphenyl)-s-triazine, 2,4-bis(2,4-dimethylphenyl)-6-[2-hydroxy-4-(3-nonyloxy*-2-hydroxypropyloxy)-5-α-cumyl-phenyl]-s-triazine (* denotes a mixture of octyloxy, nonyloxy and decyloxy groups), methylenebis-{2,4-bis(2,4-dimethylphenyl)-6-[2-hydroxy-4-(3-butyloxy-2-hydroxy-propoxy)phenyl]-s-triazine}, methylene bridged dimer mixture bridged in the 3:5′, 5:5′ and 3:3′ positions in a 5:4:1 ratio, 2,4,6-tris(2-hydroxy-4-isooctyloxycarbonylisopropylidene-oxyphenyl)-s-triazine, 2,4-bis(2,4-dimethylphenyl)-6-(2-hydroxy-4-hexyloxy-5-α-cumyl-phenyl)-s-triazine, 2-(2,4,6-trimethylphenyl)-4,6-bis[2-hydroxy-4-(3-butyloxy-2-hydroxy-propyloxy)phenyl]-s-triazine, 2,4,6-tris[2-hydroxy-4-(3-sec-butyloxy-2-hydroxypropyloxy)-phenyl]-s-triazine, mixture of 4,6-bis-(2,4-dimethylphenyl)-2-(2-hydroxy-4-(3-dodecyloxy-2-hydroxypropoxy)-phenyl)-s-triazine and 4,6-bis-(2,4-dimethylphenyl)-2-(2-hydroxy-4-(3-tridecyloxy-2-hydroxypropoxy)-phenyl)-s-triazine, Tinuvin® 400, Ciba Specialty Chemicals Corp., 4,6-bis-(2,4-dimethylphenyl)-2-(2-hydroxy-4-(3-(2-ethylhexyloxy)-2-hydroxypropoxy)-phenyl)-s-triazine and 4,6-diphenyl-2-(4-hexyloxy-2-hydroxyphenyl)-s-triazine.

2-Hydroxybenzophenones are, for example, the 4-hydroxy, 4-methoxy, 4-octyloxy, 4-decyloxy, 4-dodecyloxy, 4-benzyloxy, 4,2′,4′-trihydroxy and 2′-hydroxy-4,4′-dimethoxy derivatives.

Esters of substituted and unsubstituted benzoic acids are, for example, 4-tert-butylphenyl salicylate, phenyl salicylate, octylphenyl salicylate, dibenzoyl resorcinol, bis(4-tert-butylbenzoyl)resorcinol, benzoyl resorcinol, 2,4-di-tert-butylphenyl 3,5-di-tert-butyl-4-hydroxybenzoate, hexadecyl 3,5-di-tert-butyl-4-hydroxybenzoate, octadecyl 3,5-di-tert-butyl-4-hydroxybenzoate, 2-methyl-4,6-di-tert-butylphenyl 3,5-di-tert-butyl-4-hydroxybenzoate. Octyl methoxycinnamate; 2-Ethylhexyl-p-methoxycinnamate; 2-Ethylhexyl methoxycinnamate; 2-Ethylhexyl-4-methoxycinnamate; 2-Propenoic acid, 3-(4-methoxyphenyl)-, 2-ethylhexyl ester; Octinoxate; and 2-Ethylhexyl p-methoxycinnamate.

Cyanoacrylates and benzylidene malonates are, for example, α-cyano-β,β-diphenylacrylic acid ethyl ester or isooctyl ester, α-carbomethoxy-cinnamic acid methyl ester, α-cyano-β-methyl-p-methoxy-cinnamic acid methyl ester or butyl ester, α-carbomethoxy-p-methoxy-cinnamic acid methyl ester, N-(β-carbomethoxy-β-cyanovinyl)-2-methyl-indoline, dimethyl p-methoxybenzylidenemalonate, and di-(1,2,2,6,6-pentamethylpiperidin-4-yl)p-methoxybenzylidenemalonate.

Oxanilides are, for example, 4,4′-dioctyloxyoxanilide, 2,2′-diethoxyoxanilide, 2,2′-dioctyloxy-5,5′-di-tert-butoxanilide, 2,2′-didodecyloxy-5,5′-di-tert-butoxanilide, 2-ethoxy-2′-ethyloxanilide, N,N′-bis(3-dimethylaminopropyl)oxamide, 2-ethoxy-5-tert-butyl-2′-ethoxanilide and its mixture with 2-ethoxy-2′-ethyl-5,4′-di-tert-butoxanilide, mixtures of o- and p-methoxy-disubstituted oxanilides and mixtures of o- and p-ethoxy-disubstituted oxanilides.

For example, the UVA is one or more compounds selected from the group consisting of
2-(3′,5′-di-tert-amyl-2′-hydroxyphenyl)benzotriazole,
2-(3′-tert-butyl-2′-hydroxy-5′-(2-octyloxycarbonylethyl)phenyl)benzotriazole,
the transesterification product of 2-[3′-tert-butyl-5′-(2-methoxycarbonylethyl)-2′-hydroxyphenyl]-2H-benzotriazole with polyethylene glycol 300,
2-[2′-hydroxy-3′-(α,α-dimethylbenzyl)-5′-(1,1,3,3-tetramethylbutyl)phenyl]benzotriazole,
5-trifluoromethyl-2-(2-hydroxy-3-α-cumyl-5-tert-octylphenyl)-2H-benzotriazole,
2-(2′-hydroxy-5′-(2-hydroxyethyl)phenyl)benzotriazole,
2,4-bis(2-hydroxy-4-butyloxyphenyl)-6-(2,4-bis-butyloxyphenyl)-1,3,5-triazine,
the reaction product of tris(2,4-dihydroxyphenyl)-1,3,5-triazine with the mixture of α-chloropropionic esters (made from isomer mixture of C₇-C₉alcohols),
2-[4-(dodecyloxy/tridecyloxy-2-hydroxypropoxy)-2-hydroxyphenyl]-4,6-bis(2,4-dimethylphenyl)1,3,5-triazine,
2-(5′-tert.octyl-2′-hydroxyphenyl)-benzotriazole,
2-(3′-dodecyl-5′-methyl-2′-hydroxyphenyl)-benzotriazole,
2-(3′-tert.butyl-5′-(2-octyloxycarbonylethyl)-2′-hydroxyphenyl)-5-chloro-benzotriazole,
2-ethylhexyl-p-methoxycinnamate,
2,4-dihydroxybenzophenone,
2-hydroxy-4-methoxybenzophenone,
2-hydroxy-4-dodecyloxybenzophenone,
2-hydroxy-4-octyloxybenzophenone,
2,2′-dihydroxy-4-methoxybenzophenone,
α-cyano-β,β-diphenylacrylic acid ethyl ester or isooctyl ester,
α-carbomethoxy-cinnamic acid methyl ester,
α-cyano-β-methyl-p-methoxy-cinnamic acid methyl ester or butyl ester,
α-carbomethoxy-p-methoxy-cinnamic acid methyl ester,
dimethyl p-methoxybenzylidenemalonate,
di-(1,2,2,6,6-pentamethylpiperidin-4-yl)p-methoxybenzylidenemalonate
2,2′-diethoxyoxanilide,
2,2′-dioctyloxy-5,5′-di-tert-butoxanilide,
2,2′-didodecyloxy-5,5′-di-tert-butoxanilide,
2-ethoxy-2′-ethyloxanilide,
N,N′-bis(3-dimethylaminopropyl)oxamide,
2-ethoxy-5-tert-butyl-2′-ethoxanilide and its mixture with 2-ethoxy-2′-ethyl-5,4′-di-tert-butoxanilide, and
mixtures of o- and p-methoxy-disubstituted oxanilides and mixtures of o- and p-ethoxy-disubstituted oxanilides.

For example, the UVA is one or more compounds selected from the group consisting of
2-(3′-tert-butyl-2′-hydroxy-5′-(2-octyloxycarbonylethyl)phenyl)benzotriazole,
the transesterification product of 2-[3′-tert-butyl-5′-(2-methoxycarbonylethyl)-2′-hydroxyphenyl]-2H-benzotriazole with polyethylene glycol 300,
2-[2′-hydroxy-3′-(α,α-dimethylbenzyl)-5′-(1,1,3,3-tetramethylbutyl)phenyl]benzotriazole,
5-trifluoromethyl-2-(2-hydroxy-3-α-cumyl-5-tert-octylphenyl)-2H-benzotriazole,
the reaction product of tris(2,4-dihydroxyphenyl)-1,3,5-triazine with the mixture of α-chloropropionic esters (made from isomer mixture of C₇-C₉alcohols),
2-[4-(dodecyloxy/tridecyloxy-2-hydroxypropoxy)-2-hydroxyphenyl]-4,6-bis(2,4-dimethylphenyl)1,3,5-triazine,
2-(3′-dodecyl-5′-methyl-2′-hydroxyphenyl)-benzotriazole,
2-(2′-hydroxy-5′-(2-hydroxyethyl)phenyl)benzotriazole,
2,2′-dihydroxy-4-methoxybenzophenone,
2,2′,4,4′-tetrahydroxybenzophenone,
α-cyano-β,β-diphenylacrylic acid ethyl ester or isooctyl ester,
di-(1,2,2,6,6-pentamethylpiperidin-4-yl)p-methoxybenzylidenemalonate, and
2-ethoxy-2′-ethyloxanilide,

The HALS included in the composition may be any such additives, or mixture of HALS, many of which are well known in the art. The HALS may also be oligomeric or polymeric.

HALS are, for example, 4-hydroxy-2,2,6,6-tetramethylpiperidine, 1-allyl-4-hydroxy-2,2,6,6-tetramethylpiperidine, 1-benzyl-4-hydroxy-2,2,6,6-tetramethylpiperidine, bis(2,2,6,6-tetramethyl-4-piperidyl)sebacate, bis(2,2,6,6-tetramethyl-4-piperidyl)succinate, bis(1,2,2,6,6-pentamethyl-4-piperidyl)sebacate, bis(1-octyloxy-2,2,6,6-tetramethyl-4-piperidyl)sebacate, bis(1,2,2,6,6-pentamethyl-4-piperidyl)n-butyl-3,5-di-tert-butyl-4-hydroxybenzylmalonate, the condensate of 1-(2-hydroxyethyl)-2,2,6,6-tetramethyl-4-hydroxypiperidine and succinic acid, linear or cyclic condensates of N,N′-bis(2,2,6,6-tetramethyl-4-piperidyl)hexamethylenediamine and 4-tert-octylamino-2,6-dichloro-1,3,5-triazine, tris(2,2,6,6-tetramethyl-4-piperidyl)nitrilotriacetate, tetrakis-(2,2,6,6-tetramethyl-4-piperidyl)-1,2,3,4-butane-tetracarboxylate, 1,1′-(1,2-ethanediyl)-bis(3,3,5,5-tetramethylpiperazinone), 4-benzoyl-2,2,6,6-tetramethylpiperidine, 4-stearyloxy-2,2,6,6-tetramethylpiperidine, bis(1,2,2,6,6-pentamethylpiperidyl)-2-n-butyl-2-(2-hydroxy-3,5-di-tert-butylbenzyl)malonate, 3-n-octyl-7,7,9,9-tetramethyl-1,3,8-triazaspiro[4.5]decan-2,4-dione, bis(1-octyloxy-2,2,6,6-tetramethylpiperidyl)sebacate, bis(1-octyloxy-2,2,6,6-tetramethylpiperidyl)succinate, linear or cyclic condensates of N,N′-bis-(2,2,6,6-tetramethyl-4-piperidyl)hexamethylenediamine and 4-morpholino-2,6-dichloro-1,3,5-triazine, the condensate of 2-chloro-4,6-bis(4-n-butylamino-2,2,6,6-tetramethylpiperidyl)-1,3,5-triazine and 1,2-bis(3-aminopropylamino)ethane, the condensate of 2-chloro-4,6-di-(4-n-butylamino-1,2,2,6,6-pentamethylpiperidyl)-1,3,5-triazine and 1,2-bis-(3-aminopropylamino)ethane, 8-acetyl-3-dodecyl-7,7,9,9-tetramethyl-1,3,8-triazaspiro[4.5]decane-2,4-dione, 3-dodecyl-1-(2,2,6,6-tetramethyl-4-piperidyl)pyrrolidin-2,5-dione, 3-dodecyl-1-(1,2,2,6,6-pentamethyl-4-piperidyl)pyrrolidine-2,5-dione, a mixture of 4-hexadecyloxy- and 4-stearyloxy-2,2,6,6-tetramethylpiperidine, a condensation product of N,N′-bis(2,2,6,6-tetramethyl-4-piperidyl)hexamethylenediamine and 4-cyclohexylamino-2,6-dichloro-1,3,5-triazine, a condensation product of 1,2-bis(3-aminopropylamino)ethane and 2,4,6-trichloro-1,3,5-triazine as well as 4-butylamino-2,2,6,6-tetramethylpiperidine (CAS Reg. No. [136504-96-6]); N-(2,2,6,6-tetramethyl-4-piperidyl)-n-dodecylsuccinimid, N-(1,2,2,6,6-pentamethyl-4-piperidyl)-n-dodecylsuccinimid, 2-undecyl-7,7,9,9-tetramethyl-1-oxa-3,8-diaza-4-oxo-spiro[4,5]decane, a reaction product of 7,7,9,9-tetramethyl-2-cycloundecyl-1-oxa-3,8-diaza-4-oxospiro[4,5]decane and epichlorohydrin, 1,1-bis(1,2,2,6,6-pentamethyl-4-piperidyloxycarbonyl)-2-(4-methoxyphenyl)ethene, N,N′-bis-formyl-N,N′-bis(2,2,6,6-tetramethyl-4-piperidyl)hexamethylenediamine, diester of 4-methoxy-methylene-malonic acid with 1,2,2,6,6-pentamethyl-4-hydroxypiperidine, poly[methylpropyl-3-oxy-4-(2,2,6,6-tetramethyl-4-piperidyl)]siloxane, reaction product of maleic acid anhydride-α-olefin-copolymer with 2,2,6,6-tetramethyl-4-aminopiperidine or 1,2,2,6,6-pentamethyl-4-aminopiperidine.

The sterically hindered amine may also be one of the compounds described in U.S. Pat. Nos. 5,980,783; 6,046,304 and 6,297,299, the disclosures of which are hereby incorporated by reference.

HALS are also sterically hindered amines substituted on the N-atom by a hydroxy-substituted alkoxy group, for example, compounds such as 1-(2-hydroxy-2-methylpropoxy)-4-octadecanoyloxy-2,2,6,6-tetramethylpiperidine, 1-(2-hydroxy-2-methylpropoxy)-4-hexadecanoyloxy-2,2,6,6-tetramethylpiperidine, the reaction product of 1-oxyl-4-hydroxy-2,2,6,6-tetramethylpiperidine with a carbon radical from t-amylalcohol, 1-(2-hydroxy-2-methylpropoxy)-4-hydroxy-2,2,6,6-tetramethylpiperidine, 1-(2-hydroxy-2-methylpropoxy)-4-oxo-2,2,6,6-tetramethylpiperidine, bis(1-(2-hydroxy-2-methylpropoxy)-2,2,6,6-tetramethylpiperidin-4-yl)sebacate, bis(1-(2-hydroxy-2-methylpropoxy)-2,2,6,6-tetramethylpiperidin-4-yl)adipate, bis(1-(2-hydroxy-2-methylpropoxy)-2,2,6,6-tetramethylpiperidin-4-yl)succinate, bis(1-(2-hydroxy-2-methylpropoxy)-2,2,6,6-tetramethylpiperidin-4-yl)glutarate and 2,4-bis{N-[1-(2-hydroxy-2-methylpropoxy)-2,2,6,6-tetramethylpiperidin-4-yl]-N-butylamino}-6-(2-hydroxyethyl-amino)-s-triazine.

For example, the HALS is one or more compounds selected from the group consisting of
bis(1,2,2,6,6-pentamethylpiperidin-4-yl)sebacate,
bis(1-octyloxy-2,2,6,6-tetramethylpiperidin-4-yl)sebacate,
bis(2,2,6,6-tetramethylpiperidin-4-yl)sebacate,
7-Oxa-3,20-diazadispiro[5.1.11.2]heneicosane-20-propanoic acid, 2,2,4,4-tetramethyl-21-oxo-, dodecyl ester,
3-dodecyl-1-(2,2,6,6-tetramethyl-4-piperidinyl)-2,5-Pyrrolidinedione,
1-acetyl-4-(3-dodecyl-2,5-dioxo-1-pyrrolidinyl)-2,2,6,6-tetramethyl-piperidine,
2,4-bis[N-Butyl-N-(1-cyclohexyloxy-2,2,6,6 tetramethylpiperidin-4-yl)amino]-6-(2-hydroxyethylamine)-1,3,5-triazine,
4-hydroxy-2,2,6,6-tetramethylpiperidine,
4-hydroxy-1,2,2,6,6-pentamethylpiperidine,
2-undecyl-7,7,9,9-tetramethyl-1-oxa-3,8-diaza-4-oxo-spiro[4,5]decane,
bis(2,2,6,6-tetramethylpiperidin-4-yl)sebacate,
polycondensation product of 2,4-dichloro-6-tert-octylamino-s-triazine and 4,4′-hexa methylenebis(amino-2,2,6,6-tetramethylpiperidine),
bis(1,2,2,6,6-pentamethylpiperidin-4-yl)sebacate,
4-stearyloxy-2,2,6,6-tetramethylpiperidine,
N,N′,N″,N′″-tetrakis[(4,6-bis(butyl-1,2,2,6,6-pentamethylpiperidin-4-yl)-amino-s-triazin-2-yl]-1,10-diamino-4,7-diazadecane,
N-2,2,6,6-tetramethylpiperidin-4-yl-n-dodecylsuccinimide,
N-1,2,2,6,6-pentamethylpiperidin-4-yl-n-dodecylsuccinimide,
4-C₁₅-C₁₇alkanoyloxy-2,2,6,6-tetramethylpiperidine,
1,5-bis(2,2,6,6-tetramethylpiperidin-4-yl)-1,5-diaza-4-oxopropane,
1,3,5-tris[3-(2,2,6,6-tetramethylpiperidin-4-ylamino)-2-hydroxy-propyl)isocyanurate,
di-(1,2,2,6,6-pentamethylpiperidin-4-yl)p-methoxybenzylidenemalonate and
the polycondensation product of 2,4-dichloro-6-[N-butyl-N-(2,2,6,6-tetramethylpiperidin-4-yl)amino]-s-triazine and 1,10-diamino-4,7-diazadecane.

For example, the HALS is one or more compounds selected from the group consisting of
bis(1,2,2,6,6-pentamethylpiperidin-4-yl)sebacate,
bis(1-octyloxy-2,2,6,6-tetramethylpiperidin4-yl)sebacate,
bis(2,2,6,6-tetramethylpiperidin-4-yl)sebacate,
7-Oxa-3,20-diazadispiro[5.1.11.2]heneicosane-20-propanoic acid, 2,2,4,4-tetramethyl-21-oxo-, dodecyl ester,
3-dodecyl-1-(2,2,6,6-tetramethyl-4-piperidinyl)-2,5-pyrrolidinedione,
1-acetyl-4-(3-dodecyl-2,5-dioxo-1-pyrrolidinyl)-2,2,6,6-tetramethyl-piperidine, and
2,4-bis[N-Butyl-N-(1-cyclohexyloxy-2,2,6,6 tetramethylpiperidin-4-yl)amino]-6-(2-hydroxyethylamine)-1,3,5-triazine.

In order to form the coating composition, the light stabilizers are mixed with the non-reactive carrier and any other ancillary materials of the composition according to any technique, the particular mixture nor processing being critical to this invention. The specific UVAs and HALs selected will depend on the composition of the carrier. For example, the stabilizers selected must form a solution, suspension or emulsion stable enough to allow for an even and efficient application to the polymeric substrate.

The rheology should ideally be pseudoplastic, allowing for easy application during shear-thinning processes such as spraying, yet quickly recovering viscosity upon deposition and removal of the shear.

The rate at which a stabilizer diffuses from a specific carrier into the polymeric substrate will also impact the selection of both stabilizer and concentration employed.

The amount of stabilizer present in the coating composition will also depend on the form of the coating and manner of application to the substrate. The coating composition may be in liquid, emulsified liquid, gel or low melting solid form. It is essential that the light stabilizers remain in contact with the polymer surface long enough to allow the diffusion of stabilizer into the polymer. The coating formulations therefore have the following properties.

If a liquid, the coating composition during application has a viscosity, when measured by a Brookfield Viscometer using a #4 spindle at 20 rpm, of at least about 500 cps, for example between about 500 and about 10,000 cps, for example between about 500 and about 5000 cps, or for example between about 1000 and about 2500 cps.

The thickness of the coating composition so provided on the polymeric substrate is between about 25 and about 1000 microns as applied, although choosing the optimal thickness will be dependent on several factors including UVA and HALS concentration in the composition, and would be within the skill of one in the art in view of the present disclosure. For example, the coating composition is applied to a wet film thickness of between about 50 and 600 microns, for example between about 50 and 200 microns.

This layer may dry through evaporation of volatile components to leave a film much thinner than 25 to 1000 microns, provided that the amount of light stabilizer, UVA and HALS together, held over the polymer surface remains at least 0.2 g/m2 throughout the time required for diffusion. For example, the total amount of light stabilizer, contained within the coating layer, either wet film or dry film, is between about 0.2 g/m² and about 10 g/m², or between about 0.5 g/m² and 6 g/m². For example, the coating composition is formulated and applied to leave a coherent layer on the polymer surface that provides between about 0.5 g/m² and about 2 g/m² of light stabilizer on the polymer surface.

For such liquid formulations, the amount of stabilizer in the coating composition upon application is between about 0.1% and about about 10% by weight. For example, the formulated coating contains between about 0.2 to about 5% weight light stabilizer, for example about 0.4 to about 2% weight light stabilizer. The light stabilizer in the formulation can be comprised entirely of UVA, entirely of HALS, or a mixture of UVA and HALS which together equal the percentage by weight detailed herein. For example, the weight ratio of UVA to HALS is between about 9:1 and about 1:9, or between about 3:1 and 1:3. For example the weight ratio of UVA to HALS is about 1:1.

If the coating is applied as a gel, thick oil or waxy solid, the viscosity of the coating during application will be much higher, but the application methods, e.g., spreading the coating with a cloth or brush, may leave a much thinner initial layer. In this case the concentration of LS in the coating will generally be higher to attain the minimum of approximately 0.2 g/m² minimum of light stabilizer on the polymer surface.

In such a coating applied as a gel, oil or waxy solid, the light stabilizer, comprises at least about 5 weight percent of the composition, based on the total weight of the composition and may even comprise substantially almost all of the composition. Preferably, the light stabilizer comprises between about 8 and about 50 weight percent of the composition. For example, a coating composition of the present invention that is a gel, oil or waxy solid comprises between about 10 and about 30 weight percent of the composition.

Regardless of composition form or method of application, neither of which is critical to practicing the invention, the coating is formulated to leave at least 0.2 g/m² of light stabilizer, ideally between about 0.5 g/m² and about 2 g/m² deposited on the polymer surface throughout the time required for diffusion.

In light of the present disclosure, the exact formulations can be readily determined through routine experimentation by one of ordinary skill in the art.

The primary role of the carrier is to allow for the even application and intimate contact of the LS with the polymer surface. Optionally, the carrier may also include a substantially non-volatile solvent capable of swelling the substrate one solvent being glycerin.

Useful carriers may be a single component or a mixture of materials chosen from the groups consisting of solvents, organic oligomers and polymers, rheology modifiers including thickeners, surfactants, soaps including soaps based on salts of fatty acids for example sodium lauryl sulfate, silicones and emulsifiers.

Examples of useful solvents include, but are not limited to water, hydrocarbon solvents for example octane, decane, dodecane, hexadecane, Stoddard solvent and Isopar solvents, fluorocarbons, aromatic solvents for example xylene and mesitilene, alcohols for example methanol, ethanol propanol, isopropanol, buutanol, iso butanol, t-butanol, hexanol, octanol, cylohexanol, decanol, fatty alcohols, glycols including ethylene glycol and propylene glycol, ketones for example acetone, butanone, pentanone, cyclopentanone and cyclohexanone, esters including acetate esters of aliphatic alcohols, amides, and ureas.

Organic oligomers and polymers include, but are not limited to petroleum jelly, parrafin oil, mineral oils, polyacrylic acid, acrylic oligomers, polyacrylates and polyacryllamides.

Thickeners and rheology modifiers include, but are not limited to pseudoplastic thixotropes, such as VISCALEX® AT89 (liquid dispersion acryllic acid copolymer) or VISCALEX® HV 30 (methacryllic acid copolymer associative thickener), Newtonian fluids, acrylic polymers, cross-linked acrylic polymers, associative thickeners, alginates, carrageenan, cellulose and derivatives (carboxymethylcellulose derivatives with different counterions such as sodium potassium, etc; hydroxypropyl cellulose, hydroxyethyl cellulose, hydroxypropylmethylcellulose, methylcellulose), guar, guar derivatives, locust bean gum, xanthan gum, organoclays, water-swellable clays, silica, polyvinylpyrrolidones, polyethylene, polyethylene oxide, alkali swellable emulsion thickeners (ASE), hydrophobically modified ASE's (HASE), hydrophobically modified urethane thickener (HEUR) and liquid dispersion polymers (LDPs).

Useful surfactants include, but are not limited to anionic surfactants, for example sulfonates, carboxylates, sulfates and phosphates; nonionic surfactants, for example acetylenic glycol, alkylpolyglycoside, alcohol ethoxylate, alkylphenol ethoxylate, alkanolamide, block copolymers, dialkylsiloxanes and fluorosurfactants; cationic surfactants, for example quarternary amines, and amphoterics, for example N-alkylbetaines.

The coating compositions of the invention may optionally also contain from about 0.01 to about 10%, preferably from about 0.025 to about 5%, and especially from about 0.1 to about 2% by weight of various conventional additives, such as the materials listed below, or mixtures thereof.

Antioxidants including alkylated monophenols, alkylthiomethylphenols, hydroquinones and alkylated hydroquinones, tocopherols, hydroxylated thiodiphenyl ethers, alkylidenebisphenols, benzyl compounds, hydroxybenzylated malonates, aromatic hydroxybenzyl compounds, benzylphosphonates, acylaminophenols, esters of β-(3,5-di-tert-butyl-4-hydroxyphenyl)propionic acid, esters of β-(5-tert-butyl-4-hydroxy-3-methylphenyl)propionic acid, esters of β-(3,5-dicyclohexyl-4-hydroxyphenyl)propionic acid, esters of 3,5-di-tert-butyl-4-hydroxyphenyl acetic acid, amides of β-(3,5-di-tert-butyl-4-hydroxyphenyl)propionic acid, ascorbic acid, aminic antioxidants, phenothiazines phosphites and phosphonites;

Metal deactivators, for example N,N′-diphenyloxamide, N-salicylal-N′-salicyloyl hydrazine, N,N′-bis(salicyloyl)hydrazine, N,N′-bis(3,5-di-tert-butyl-4-hydroxyphenylpropionyl)hydrazine, 3-salicyloylamino-1,2,4-triazole, bis(benzylidene)oxalyl dihydrazide, oxanilide, isophthaloyl dihydrazide, sebacoyl bisphenylhydrazide, N,N′-diacetyladipoyl dihydrazide, N,N′-bis(salicyloyl)oxalyl dihydrazide, N,N′-bis(salicyloyl)thiopropionyl dihydrazide;

Hydroxylamines, nitrones and amine oxides, for example amine oxide derivatives as disclosed in U.S. Pat. Nos. 5,844,029 and 5,880,191, didecyl methyl amine oxide, tridecyl amine oxide, tridodecyl amine oxide and trihexadecyl amine oxide;

Benzofuranones and indolinones, for example those disclosed in U.S. Pat. Nos. 4,325,863, 4,338,244, 5,175,312, 5,216,052, 5,252,643 5,369,159 5,356,966 5,367,008 5,428,177 or 5,428,162 or 3-[4-(2-acetoxyethoxy)phenyl]-5,7-di-tert-butyl-benzofuran-2-one, 5,7-di-tert-butyl-3-[4-(2-stearoyloxyethoxy)phenyl]benzofuran-2-one, 3,3′-bis[5,7-di-tert-butyl-3-(4-[2-hydroxyethoxy]phenyl)benzofuran-2-one], 5,7-di-tert-butyl-3-(4-ethoxy-phenyl)benzofuran-2-one, 3-(4-acetoxy-3,5-dimethylphenyl)-5,7-di-tert-butyl-benzofuran-2-one, 3-(3,5-dimethyl-4-pivaloyloxyphenyl)-5,7-di-tert-butyl-benzofuran-2-one, 3-(3,4-dimethylphenyl)-5,7-di-tert-butyl-benzofuran-2-one, Irganox® HP-136, Ciba Specialty Chemicals Corp., and 3-(2,3-dimethylphenyl)-5,7-di-tert-butyl-benzofuran-2-one; and

Thiosynergists, for example dilauryl thiodipropionate or distearyl thiodipropionate.

Other additives, for example dispersing agents, plasticizers, pigments, dyes, optical brighteners, flow-control agents, flameproofing agents, antistatic agents, clarifiers, preservatives and biocides.

The method of applying the coating of the composition is dependent in part on the composition characteristics, for example liquid or waxy solid, and is not critical to the invention. Application of the coating may be accomplished by spaying or spreading with an appropriate applicator, for example, a cloth, sponge, brush or other device used in the applications of a polish, oil, soap or wax.

One method of application is to spray the coating in liquid form onto the polymeric material to leave a coating, either as a wet film layer or a viscous liquid or emulsion, of the thickness described above.

The coating is allowed to remain in contact with the polymeric material substrate for a time sufficient to cause the light stabilizers present in the composition to diffuse into the polymer, e.g., the coating, film, molded article or composite. As with many migration processes, the LS of the present invention would be expected to diffuse into the substrate more quickly on a warm day than on a cold day. Light absorbed, e.g., sunlight, by the polymeric article will also increase the diffusion of stabilizer as it will warm the polymer surface.

In a typical application, a stabilizing coating composition applied in the morning of a warm or sunny day would be removed that same evening. For example, the exterior of an automobile in the sun can readily achieve temperatures of 35-45° C. and higher depending on the color. Of course, the coating can remain on the article longer, or indefinitely, if it is inconvenient to either wash or remove the coating residue after application.

Following diffusion of LS into the polymeric material substrate, the residual composition material can be left on the substrate or removed, e.g., by washing.

According to the present invention method, LS in the composition diffuses into the substrate and is not just present as a surface coating on the substrate.

In view of this disclosure, many modifications of this invention will be apparent to those skilled in the art. It is intended that all such modifications which fall within the true scope of the invention will be included within the terms of the appended claims.

### WORKING EXAMPLES

The following non-limiting examples illustrate the invention.

UVA 1—2-(3′-tert-butyl-2′-hydroxy-5′-(2-octyloxycarbonylethyl)phenyl)benzotriazole,

UVA 2—the transesterification product of 2-[3′-tert-butyl-5′-(2-methoxycarbonylethyl)-2′-hydroxyphenyl]-2H-benzotriazole with polyethylene glycol 300,

UVA 3—2-[2′-hydroxy-3′-(α,α-dimethylbenzyl)-5′-(1,1,3,3-tetramethylbutyl)phenyl]ben-zotriazole,

UVA 4—the reaction product of tris(2,4-dihydroxyphenyl)-1,3,5-triazine with the mixture of α-chloropropionic esters (made from isomer mixture of C₇-C₉alcohols),

UVA 5 2-[4-(dodecyloxy/tridecyloxy-2-hydroxypropoxy)-2-hydroxyphenyl]-4,6-bis(2,4-dimethylphenyl)1,3,5-triazine,

UVA 6 2-(3′-dodecyl-5′-methyl-2′-hydroxyphenyl)-benzotriazole,

UVA 7 2,2′-dihydroxy-4-methoxybenzophenone

UVA 8α-cyano-β,β-diphenylacrylic acid ethyl ester or isooctyl ester

HALS 1—bis(1-octyloxy-2,2,6,6-tetramethylpiperidin-4-yl)sebacate,

HALS 2—bis(1,2,2,6,6-pentamethylpiperidin-4-yl)sebacate,

HALS 3—7-Oxa-3,20-diazadispiro[5.1.11.2]heneicosane-20-propanoic acid, 2,2,4,4-tetramethyl-21-oxo-, dodecyl ester

HALS 4—3-dodecyl-1-(2,2,6,6-tetramethyl-4-piperidinyl)-2,5-Pyrrolidinedione,

HALS 5—2,4-bis[N-Butyl-N-(1-cyclohexyloxy-2,2,6,6 tetramethylpiperidin-4-yl)amino]-6-(2-hydroxyethylamine)-1,3,5-triazine

VISCALEX® AT89 is a liquid dispersion acryllic acid copolymer.

VISCALEX® HV 30 is a methacryllic acid copolymer associative thickener.

ISOPAR® H, TEXANOL® and Stoddard solvent are high boilng commercial hydrocarbon based solvents

The following non-limiting examples illustrate compositions useful as coatings in the present invention. Other formulations would be obvious to one skilled in the art in light of the present disclosure. All percentages are approximate weight percents of the total composition.

Example 1

| | |
|---|---|
| High Viscosity Silicone | 15% |
| Low Viscosity Silicone | 10% |
| UVA 1 | 5% |
| HALS 1 | 5% |
| Emulsifier | 4% |
| VISCALEX ® AT89/ISOPAR ® H 1:1 | 2% |
| Water | 59% |

Example 2

| | |
|---|---|
| ISOPAR ® Solvent | 25% |
| UVA 8 | 5% |
| HALS 2 | 2.5% |
| sulfosuccinate wetting agent | 0.2% |
| aminomethylpropanol | 0.3% |
| VISCALEX ® HV 30 | 1% |
| Water | 66% |

Example 3

| | |
|---|---|
| Paraffin Oil | 30% |
| UVA 4 | 3% |
| HALS 1 | 1.5% |
| WITCONATE ® P10-59 (wetting agent) | 1% |
| Triton X100 (biocide) | 1% |
| aminomethylpropanol | ˜0.3% |
| RHEOVIS ® 152 (reology modifyer) | 1% |
| Water | 62.2% |

Example 4

| | |
|---|---|
| Montan wax | 50% |
| Aliphatic hydrocarbon solvent | 35% |
| HALS 1 | 5% |
| Hydrogenated Castor wax | 10% |

Example 5

| | |
|---|---|
| Stoddard solvent | 20% |
| UVA 5 | 2% |
| Low MW Silicone | 10% |
| OPTIFLO ® H400 thickener (Sud-Chemie) | 5% |
| Morpholine oleate | 5% |
| Water | 58% |

Example 6

| | |
|---|---|
| Texanol | 30% |
| UVA 2 | 5% |
| HALS 2 | 2% |
| VISCALEX ® HV 30 | 2% |
| aminomethylpropanol | ˜0.3% |
| Water | 60.7% |

Example 7

| | |
|---|---|
| High Viscosity Silicone | 15% |
| Low Viscosity Silicone | 10% |
| UVA 1 | 1% |
| HALS 1 | 1% |
| Emulsifier | 4% |
| VISCALEX ® AT89/ISOPAR ® H 1:1 | 2% |
| Water | 67% |

Example 8

| | |
|---|---|
| Isopar Solvent | 25% |
| UVA 7 | 1% |
| HALS 2 | 0.5% |
| Alcopol O | 0.2% |
| aminomethylpropanol | 0.3% |
| VISCALEX ® HV-30 | 1% |
| Water | 72% |

Example 9

| | |
|---|---|
| Paraffin Oil | 30% |
| UVA 6 | 0.6% |
| HALS 5 | 1% |
| Witconate P1059 | 1% |
| Triton X100 | 1% |
| aminomethylpropanol | ˜0.3% |
| Rheovis 152 | 1% |
| Water | 65.1% |

Example 10

| | |
|---|---|
| Montan wax | 50% |
| Aliphatic hydrocarbon solvent | 35% |
| HALS 3 | 1% |
| Hydrogenated Castor wax | 14% |

Example 11

| | |
|---|---|
| Stoddard solvent | 20% |
| HALS 2 | 1% |
| Low MW Silicone | 10% |
| OPTIFLO ® H400 thickener (Sud-Chemie) | 5% |
| Morpholine oleate | 5% |
| Water | 59% |

Example 12

| | |
|---|---|
| Texanol | 30% |
| UVA 2 | 1% |
| HALS 4 | 0.6% |
| VISCALEX ® HV 30 | 2% |
| aminomethylpropanol | ˜0.3% |
| Water | 66.1% |

Example 13

| | |
|---|---|
| High Viscosity Silicone | 15% |
| Low Viscosity Silicone | 10% |
| UVA 1 | 0.5% |
| HALS 2 | 0.5% |
| Emulsifier | 4% |
| Emulsifier | 4% |
| VISCALEX ® AT89/ISOPAR ® H 1:1 | 2% |
| Water | 68% |

The viscosity of the above compositions is adjusted, if necessary, by standard means to between 1000 and 2000 cps when measured by a Brookfield Viscometer using a #4 spindle at 20 rpm. The coatings are applied to the polymeric substrate by spraying onto the polymer surface, e.g., auto or marine coating or molded thermoplastic article, and allowed to stand 12 hours in the sun and the residue is then washed off by conventional means.

Alternately, the coatings are applied by passing an applicator, e.g., brush, sponge, cloth or paper wipe, saturated with one of the above compositions over the surface of the polymeric or coated article. After standing 12-24 hours the residue is washed off by conventional means.

### Example 14

The following formulation illustrates a much thicker coating which is to be applied at a thinner applied film build.

| | |
|---|---|
| Paraffin Oil | 40% |
| UVA 6 | 25% |
| HALS 1 | 10% |
| Witconate P1059 | 1% |
| Triton X100 | 1% |
| aminomethylpropanol | ˜0.3% |
| Rheovis 152 | 1% |
| Water | ˜12% |
| Hydrogenated Castor wax | ˜10% |

The formulation is homogenized and applied to the polymer with a cloth to leave an even coat. After 12-18 hours the residue is removed by conventional washing.

### Example 15

The carrier can also comprise commercial cleaning and maintenance products such as cleansers, polishes and waxes. The addition of the viscosity enhancing agent, Viscalex 1889 diluted in 50% lsoparH, provides the wet film build and coating tenacity (the ability for the coating to remain in contact for the duration of the method), needed for adequate stabilizer migration.

| | |
|---|---|
| Commercial Aqueous Car Wax | 85.0 grams |
| UVA 1 | 0.45 grams |
| HALS 1 | 0.45 grams |
| VISCALEX ® AT89/ISOPAR ® H 1:1 | 2.0 grams |

The above formulation is applied to a steel panel and plastic panel coated with a typical automotive acrylic/melamine coating and is allowed to rest for one day outdoors at a 5-degree angle on a sunny day. The maximum temperature reached by the panels is 47° C. The following day the panels are washed and upper layers of the coating are removed by microtoming. Extraction of the microtomed layers and analysis of the extracts by UV spectroscopy show migration of the UVA into the top 7 micron of the coating to a concentration of 0.5% per weight of coating.

### Example 16

In the following Example, compositions of the present invention are applied to weathered substrates. The UV absorption at 345 nm is used to determine the amount of UVA present using a Perkin Elmer Lambda 800 double beam spectrometer.

Quartz discs are spin coated with a model formulation of a commercial high solids thermoset acrylic melamine auto clear coat containing UVA 3, 1.5 weight % based on resin solids, and HALS 1, 1.0 weight % based on resin solids to yield after curing for 30 minutes at 250° F. films approximately 20 microns thick as measured by a Ziess Interferometer. The discs are exposed in an Atlas Ci65 Xenon Weatherometer under SAE J 1960 cycle with borosilicate inner and outer filters at 0.55 W/m² for 500 hours.

After each 500 hour exposure interval, absorption spectra are obtained, samples are treated with one of the formulations below, stored in an oven at 55° C. for 24 hours to simulate the heat generated by sunlight on a car surface, after which the samples are thoroughly washed, first with a water/dish detergent mixture then with an isopropanol/water mixture, absorption spectra are taken, and the samples returned to the Weatherometer. One set of samples is left untreated for comparison.

Both stabilizer containing coating compositions of the present invention contain:

10 grams of a 60% aqueous emulsion of a non-ionic medium viscosity polydimethylsiloxane

90 grams of water

1.5 grams of a thickener

0.5 grams of aminomethylpropanol

1.2 grams of a glycol.

Formulation A also contains 1.2 grams of UVA 1.

Formulation B also contains 1.2 grams of UVA 1 and 1.2 grams of HALS 1.

The data appear in the table below.

| | Film | Absorption at 347 nm | | | | |
|---|---|---|---|---|---|---|
| Disc | Thickness | 0 hr | 500 hr | 500 hr AT | 1000 hr | 1000 hr AT |

Untreated

| | | | | | | |
|---|---|---|---|---|---|---|
| 1-1 | 20.5 micron | 1.345 | 1.243 | — | 1.150 | — |
| 1-2 | 20.6 | 1.394 | 1.295 | — | 1.190 | — |
| 1-3 | 22.8 | 1.456 | 1.343 | — | 1.239 | — |

Treated with Formulation A

| | | | | | | |
|---|---|---|---|---|---|---|
| 2-1 | 22.5 micron | 1.368 | 1.254 | >4 | >4 | >4 |
| 2-2 | 21.4 | 1.427 | 1.319 | >4 | >4 | >4 |
| 2-3 | 22.8 | 1.466 | 1.375 | >4 | 2.837 | 3.035 |

Treated with Formulation B

| | | | | | | |
|---|---|---|---|---|---|---|
| 3-1 | 23.2 micron | 1.375 | 1.280 | 2.544 | 2.393 | 3.965 |
| 3-2 | 20.9 | 1.294 | 1.187 | 2.373 | 1.300 | 1.283 |
| 3-3 | 22.2 | 1.302 | 1.209 | 2.408 | 1.453 | 1.522 |

AT is the Absorption data taken after treatment with a composition of the present invention.

### Example 17

In the following Example, Formulation A from Example 16 is applied to non-weathered, unstabilized samples. The UV absorption at 345 nm is used to determine the amount of UVA present.

Quartz discs are spin coated with a model formulation of a commercial high solids thermoset acrylic melamine auto clear coat to yield after curing for 30 minutes at 250° F. films approximately 30 microns thick as measured by a Ziess Interferometer.

The samples are treated with Formulation A from Example 16. Samples are placed outside for 2, 4 and 8 hours (stand time) then thoroughly washed as above. A separate sample is stored in an oven at 55° C. for 24 hours to simulate the heat generated by sunlight on a car surface then thoroughly washed as above. Absorption spectra are obtained and compared to the absorption spectra prior to treatment.

Absorption at 347 nm

| Disc | stand time | BT | AT |
|---|---|---|---|
| 5 | 2 hr | 0.044 | 0.067 |
| 6 | 4 hr | 0.044 | 0.074 |
| 7 | 8 hr | 0.044 | 0.618 |
| 8 | 55° C. 24 hr | 0.045 | 0.222 |

BT is the Absorption data taken prior to treatment with a composition of the present invention.
AT is the Absorption data taken after treatment with a composition of the present invention.

In each case, UVA 1 is absorbed by the sample film.

Comparison between Example 16 and disc 8 and Example 16 suggests that previously exposed films more readily absorb additive.

### Example 18

A commercial biaxially orientated polypropylene packaging film and a formulated polypropylene cast film were treated with the Formulation A following the procedure of Example 16. The UV absorption at 345 nm is used to determine the amount of UVA Present.

Absorption at 347 nm

| | BT | AT |
|---|---|---|
| biaxially orientated film | 0.042 | 0.474 |
| cast film | 0.134 | 1.382 |

Non-polar polyolefins readily incorporate stabilizers using the method of the present invention.

We claim:

1. A method for incorporating light stabilizers into a polymeric substrate, which method comprises the steps of:
applying to a polymeric substrate a removable coating composition comprising an effective amount of at least one light stabilizer selected from the group consisting of ultraviolet light absorbers and hindered amine light stabilizers suspended in a non-reactive carrier formulated to have sufficient viscosity or film forming properties to maintain a coherent coating layer on the polymeric substrate, which coating layer when applied contains at least 0.2 g/m² of light stabilizer, for a time sufficient to cause the light stabilizer to diffuse into the substrate; and
allowing the coating to remain in contact with the polymeric substrate for a time sufficient to cause the light stabilizer to diffuse into the substrate.

2. A method according to claim 1 where the polymeric substrate is a cured coating over a metal, polymeric, wood, composite, ceramic or fiberglass substrate.

3. A method according to claim 2 where the coating is an automotive coating selected from the group consisting of acrylic/melamine, acrylic/urethane, polyester/urethane, epoxy/acid and silicone containing coatings.

4. A method according to claim 2 where the coating is a marine gel coat.

5. A method according to claim 1 where the polymeric substrate is a thermoplastic article.

6. A method according to claim 5 where the thermoplastic article is comprised of a resin selected from the group consisting of polypropylene, polyethylene, thermoplastic polyolefins, PVC, styrenics, polyamides, aliphatic urethanes, aliphatic polyesters, ionomers, unsaturated polyester resins, natural and synthetic rubbers, and resin blends.

7. A method according to claim 1 where the polymeric substrate is a thermoset or thermoplastic film.

8. A method according to claim 7 where the thermoset or thermoplastic film is electrically conductive, semi-conductive, insulating, electrochromic, electrophoretic, protective, reflective, refractive, polarizing or IR or UV absorbing.

9. A method according to claim 1 where the polymeric substrate is a composite material comprising a polymer and particles, nano-particles or fibers of wood, glass, clay or mineral material.

10. A method according to claim 1 which comprises the further step of removing residue of the coating from said substrate after said diffusing step.

11. A method according to claim 1 wherein the polymeric substrate is exposed to outdoor or artificial weathering prior to the application of the removable coating comprising the light stabilizer.

12. A method according to claim 11 wherein the polymeric substrate is weathered by exposure to Ultra Violet light.

13. A method according to claim 1 wherein the coating composition is a liquid with a viscosity of between about 500 and about 10,000 cps when measured by a Brookfield Viscometer using a #4 spindle at 20 rpm.

14. A method according to claim 1 wherein the coating composition is a liquid with a viscosity of between about 1000 and about 2500 cps when measured by a Brookfield Viscometer using a #4 spindle at 20 rpm.

15. The method according to claim 13 wherein the light stabilizer, in total, is present from about 0.1% to about 10% by weight, based on the weight of the total composition and the weight: weight ratio of the ultraviolet light absorber to the hindered amine light stabilizer is from about 1:9 to about 9:1.

16. The method according to claim 1 wherein said ultraviolet light absorber is selected from the group consisting of benzotriazoles, ortho-hydroxybenzophenones, triphenyl triazines, benzylidene malonates, cyanoacrylates and oxanilides.

17. The method according to claim 1 wherein said ultraviolet light absorber is selected from the group consisting of
2-(3′-tert-butyl-2′-hydroxy-5′-(2-octyloxycarbonylethyl)phenyl)benzotriazole,
the transesterification product of 2-[3′-tert-butyl-5′-(2-methoxycarbonylethyl)-2′-hydroxyphenyl]-2H-benzotriazole with polyethylene glycol 300,
2-[2′-hydroxy-3′-(α,a-dimethylbenzyl)-5′-(1,1,3,3-tetramethylbutyl)phenyl]benzotriazole,
5-trifluoromethyl-2-(2-hydroxy-3-α-cumyl-5-tert-octylphenyl)-2H-benzotriazole,
the reaction product of tris(2,4-dihydroxyphenyl)-1,3,5-triazine with the mixture of α-chloropropionic esters (made from isomer mixture of C₇-C₉alcohols),
2-[4-(dodecyloxy/tridecyloxy-2-hydroxypropoxy)-2-hydroxyphenyl]4,6-bis(2,4-dimethylphenyl)1,3,5-triazine,
2-(3′-dodecyl-5′-methyl-2′-hydroxyphenyl)-benzotriazole
2-(2′-hydroxy-5′-(2-hydroxyethyl)phenyl)benzotriazole,
2,2′-dihydroxy-4-methoxybenzophenone
2,2′,4,4′-tetrahydroxybenzophenone,
α-cyano-β,β-diphenylacrylic acid ethyl ester or isooctyl ester
di-(1,2,2,6,6-pentamethylpiperidin-4-yl)p-methoxybenzylidenemalonate, and
2-ethoxy-2′-ethyloxanilide,

18. The method according to claim 1 wherein said hindered amine light stabilizer is selected from the group consisting of
bis(1,2,2,6,6-pentamethylpiperidin-4-yl)sebacate,
bis(1-octyloxy-2,2,6,6-tetramethylpiperidin-4-yl)sebacate,
bis(2,2,6,6-tetramethylpiperidin-4-yl)sebacate,
7-Oxa-3,20-diazadispiro[5.1.11.2]heneicosane-20-propanoic acid, 2,2,4,4-tetramethyl-21-oxo-, dodecyl ester,
3-dodecyl-1-(2,2,6,6-tetramethyl-4-piperidinyl)-2,5-pyrrolidinedione,
1-acetyl-4-(3-dodecyl-2,5-dioxo-1-pyrrolidinyl)-2,2,6,6-tetramethyl-piperidine, and
2,4-bis[N-Butyl-N-(1-cyclohexyloxy-2,2,6,6 tetramethylpiperidin-4-yl)amino]-6-(2-hydroxyethylamine)-1,3,5-triazine.

19. A method according to claim 1 wherein the coating composition is a gel, oil or waxy solid which coating composition comprises between about 5% and about 50% weight percent of light stabilizers based on total weight of the composition.

20. The method according to claim 1 wherein the coating composition further comprises one or more additives selected from the group consisting of antioxidants, dyes, optical brighteners, flow-control agents, antistatic agents, preservatives and biocides.
